(19) United States
(12) Patent Application Publication
(10) Pub. No.: US 2026/0168811 A1
(43) Pub. Date: Jun. 18, 2026

(54) Method for Supporting a Driver in Travelling a Predetermined Route, Computer Device for a Vehicle, Computer-Readable (Storage) Medium and Assistance System

(71) Applicant: Bayerische Motoren Werke Aktiengesellschaft, Muenchen (DE)

(72) Inventors: Patrick EBNER, Wessling OT Oberpfaffenhofen (DE); Uwe PROEMM, Eggstaett (DE); Hubert SCHOLZ, Muenchen (DE); Martin SEDLMAYR, Wessobrunn (DE)

(21) Appl. No.: 18/851,205

(22) PCT Filed: Mar. 8, 2023
(86) PCT No.: PCT/EP2023/055826

§ 371 Date: Sep. 26, 2024

(30) Foreign Application Priority Data
Apr. 13, 2022 (DE) 10 2022 109 156.2

(51) Int. Cl. G01C 21/36

(52) U.S. Cl. CPC G01C 21/3667

(57) ABSTRACT

A method for supporting a driver of a vehicle in travelling a predetermined route in traffic, including receiving route data describing the predetermined route. The method further includes determining a curve progression that describes a curvature of the predetermined route. The method further includes determining a first route section based on the curve progression, wherein the first route section describes a section of the predetermined route. Additionally, the method includes outputting route section data which describes the section of the predetermined route based on the first route section. In addition, additionally predefined perceptibility data can be received, which describes the driver's perception of the driving dynamics when travelling the section of the predetermined route. Within the scope of the method, the determining of the first route section can take place based on the perceptibility data and also taking into consideration a change in the curve progression.

### BACKGROUND AND SUMMARY

The present invention relates to a method for supporting a driver of a vehicle in traveling a predetermined route in road traffic. In addition, the present invention relates to a computing device for a vehicle for carrying out such a method. Finally, the present invention relates to a computer-readable (storage) medium and an assistance system for a vehicle.

Vehicles already often have navigation systems as a standard feature presently. Navigation systems based on global navigation satellite systems can navigate the driver to their desired destination. A map database of the navigation system can moreover be used to inform the driver of the vehicle about the route. For example, the driver can be warned if a reduction of the current speed is advisable in upcoming curves. However, for this purpose it is necessary to output an assessment about sections of the predetermined route and possibly about hazards resulting therefrom on the basis of the predetermined route or the map data.

Document DE 10 2005 021 448 A1 provides a system and a method for warning a driver about upcoming curves of the road. In general, a vehicle position determination module determines the vehicle position in a global positioning system (GPS) and a map comparison module determines the vehicle position on a map on the basis of the position in the global positioning system. A forecast module searches in the forward direction on the map for a curve, determines a candidate list of the possible driving paths through the curve, and determines the most probable path of the vehicle through the curve on this candidate list. A warning module then assesses the hazard originating from the curve for the vehicle.

The current prior art does enable the output of a warning of potentially critical curves, but no solution is disclosed for how individual sections of the predetermined route are recognized so that a reasonable assessment about the hazards resulting therefrom can be output to the driver of the vehicle. Therefore, the current prior art also does not show a solution for how the driver of a vehicle can be supported individually, in the best possible manner, and according to their driving-dynamics feeling in traveling a curve.

It is therefore the object of the present invention to disclose a solution for how a driver can be supported individually, in the best possible manner, and according to a driving-dynamics feeling when driving a predetermined route-beyond the prior art.

This object is achieved according to the invention by a method, by a computing device, by a computer-readable (storage) medium, and by an assistance system having the features according to the independent claims. Advantageous refinements of the present invention are specified in the dependent claims.

A method according to the invention for supporting a driver of a vehicle in traveling a predetermined route in road traffic comprises receiving route data, which describe the predetermined route. In addition, the method according to the invention comprises determining a curvature course, wherein the curvature course describes a curvature of the predetermined route. Moreover, the method comprises determining a first route section on the basis of the curvature course, wherein the first route section describes a section of the predetermined route. Finally, the method according to the invention also comprises outputting route section data, which describe the section of the predetermined route by means of the first route section. Additionally, predefined perceptibility data can be received, which describe a driving-dynamics feeling of the driver in traveling the section of the predetermined route. In the scope of the method according to the invention, the determination of the first route section can thus be carried out on the basis of the perceptibility data and additionally in consideration of a change of the curvature course.

In other words, the driver of the vehicle is thus to be supported when traveling the predetermined route according to the driving-dynamics feeling. In the course of this, the received route data can be divided into (curve) sections intuitively comprehensible for the driver. A curve forecast or a forecast for the predetermined route can thus be provided. Such a curve forecast or forecast for the predetermined route can thus correspond to the actual curve feeling of the driver or the actual curve feeling of a person.

As described at the outset, initially route data are received for this purpose. The route data can be provided here, for example, by a navigation system, a map database, by means of a vehicle-to-vehicle communication, or the like. The route data can also be provided by an assistance system, which determines the most probable route. Methods which determine the most probable route are also designated in the technical literature as methods for determining the most probable path. The route data describe in particular a road course located in front of the vehicle. The route data can comprise, for example, individual points of the predetermined route. It is also conceivable that the route data comprise individual node points, curvature courses, and/or radii of curvature. It is decisive that the route data are divided into intuitively comprehensible sections-for the driver-by means of the method according to the invention.

For this purpose, a curvature course of the predetermined route can be determined on the basis of the route data. For example, a radius of curvature for individual points of the route data can be determined by means of curve fitting. It is also possible that for each three successive points of the route data, an area is determined, the radius of which can then be used as the radius of curvature. Furthermore, it is conceivable that individual radii of curvature are already contained in the route data. The curvature course can be visualized, for example, in a path-curvature diagram. It is conceivable that the data are moreover smoothed. For example, a PT1 smoothing can be used for this purpose.

A first route section can thus be determined on the basis of the curvature course. The route section can be, for example, a curve, a straight line, a left-right curve, a contracting curve, a serpentine, an opening curve, or the like.

The additionally received predefined perceptibility data can underlie the determination of the first route section. The predefined perceptibility data can be provided, for example, in the form of a central storage unit. The predefined perceptibility data describe a driving-dynamics feeling of the driver in traveling the section of the predetermined route. In other words, the predefined perceptibility data thus describe how the driver perceives a specific curvature course of the predetermined route. In the simplest case, the perceptibility data can comprise absolute values, for example, which assign specific values of the curvature course to a feeling of the driver. For example, a curvature course which describes a curvature of the predetermined route having a radius greater than 500 m can thus be assigned to a straight route. Furthermore, a change of the curvature course can be taken into consideration in the determination of the first route section. It can thus be recognized by means of a change of the curvature course, for example, whether a curve of the predetermined route tapers and thus the criticality possibly increases.

One advantageous embodiment provides that the predefined perceptibility data comprise a relative value and/or a road category, wherein the relative value describes the driving-dynamics feeling relative to an adjacent section of the predetermined route and the road category characterizes a roadway. The advantageous embodiment is based on the concept that the driving-dynamics feeling of the driver or a person can depend on a previously traveled section of the predetermined route. For example, the perception of a slight curvature of the predetermined route can depend on whether the driver of the vehicle traveled a straight route section for a long time or whether the slight curvature was already preceded by a curvy route. If the perceptibility data thus comprise a relative value, in the determination of the first route section, a preceding and optionally also a following curvature of the predetermined route can be taken into consideration on the basis of the curvature course.

The behavior can be similar with the road category. For example, it makes a difference whether a slight curve is traveled on an asphalt roadway or a dirt road. A slight curve on a dirt road can thus already result in a critical situation for the driver of the vehicle, for example. In other words, the driving-dynamics feeling can thus depend on the road category. Possible road categories can thus comprise asphalt roads, gravel roads, dirt roads, urban roads, mountain pass roads, freeways, main roads, or the like.

It is moreover advantageous if the route section data comprise at least one first route section point and one second route section point. The first route section point can describe, for example, a curve beginning or a beginning of the section of the predetermined route described by the first route section. The second route section point can describe, for example, a vertex of the section of the predetermined route described by the first route section. Additionally or alternatively, the second route section point can also describe a center point or the like of the section of the predetermined route described by the first route section. The first route section point and the second route section point can be used to control a temporal output of the route section data to the driver of the vehicle. On the basis of the first route section point, the driver of the vehicle can thus be notified of the beginning of the first route section. The notification can be output, for example, up to the second route section point (for example up to the vertex of a curve).

It can moreover be advantageous if the section of the predetermined route described by the first route section represents a curve. This is advantageous in particular if the driver is supposed to be warned of certain curves.

Furthermore, it can be advantageous if a direction change of the section of the predetermined route described by the first route section is additionally determined in the determination of the first route section and the first route section is characterized as a curve if the direction change exceeds a predetermined direction change threshold value.

The direction change of a or the section of the predetermined route can describe, for example, which angle lies between the beginning of the section and an end of the section. The direction change can thus be 90°, for example, in the case of a 90° curve. One advantage of the determination of the direction change can be that outliers in the route data can be corrected. If a section of the predetermined route has a certain minimum curvature, for example, this could result in the determination of a first route section, although under certain circumstances the curvature is only to be attributed to an outlier in the route data. However, if one presumes that the direction change at the end of the first route section in relation to the beginning of the first route section exceeds a predetermined direction change threshold value, outliers in the route data can be compensated for. It can be advantageous here if the predetermined direction change threshold value is, for example, 10°, 15°, 18°, 21°, or 25°.

Furthermore, it is advantageous if in addition to the determination of the first route section, at least one further route section is determined on the basis of the curvature course, wherein the at least one further route section is adjacent to the first route section and a sign of the curvature course of the first route section and the at least one further route section is identical. If a first route section and at least one further route section are determined, a contracting curve can thus be identified, for example. In a contracting curve, the curvature course can have an identical sign. In such a case, the first route section and the at least one further route section can thus describe a bend in the same direction. The determination of the first route section and the additional at least one further route section enable a more finely-granular characterization of the predetermined route section or the section of the predetermined route. The intuitive feeling of the driver can thus be described in a finely-granular and precise manner by means of the route section data.

Finally, it is also advantageous if the curvature course has a saddle point in an area which comprises the first route section and the second route section, wherein the saddle point is characterized by the change of the curvature course which falls below a curvature course change threshold value for a predetermined distance. In contracting curves, it can occur that the curvature course initially grows linearly, the change of the curvature course (for example the gradient of the curvature course) decreases, and then grows up to the maximum curve radius of the contracting curve. Finally, the curvature course can then decrease again from the maximum of the contracting curve. To describe such a contracting curve, a first route section and an additional second route section can be advantageous. More precise route section data can thus be provided to the driver of the vehicle. The driver of the vehicle can thus be supported in traveling the predetermined route in an intuitive manner and according to their driving-dynamics feeling.

One advantageous embodiment furthermore also provides that in addition to the determination of the first route section, at least one further route section is determined on the basis of the curvature course. The at least one further route section is adjacent to the first route section and a sign of the curvature course of the first route section is different (in this advantageous embodiment) from a sign of the curvature course of the at least one further route section. Furthermore, the route section data (in this advantageous embodiment) can describe the section of the predetermined route by means of the first route section and the at least one further route section as a serpentine.

A serpentine can describe a sequence of left-right curves. For example, a serpentine can thus be a serpentine route. In particular, it is conceivable that the individual curves of the sequence of left-right curves only have a minor direction change and therefore are intuitively not perceived as individual curves by the driver. In other words, it can occur that the individual curves of the sequence of left-right curves are intuitively perceived as a cohesive route section and therefore should be described as a serpentine. The sequence of left-right curves can in particular be characterized by changes of the sign of the curvature course.

It can also be advantageous here if, in the determination of the first route section and the at least one further route section, a direction change of the section of the predetermined route described by the respective route section is additionally determined. The route section data can thus describe the section of the predetermined route as a serpentine even if the respective direction change is located within a respective relative direction change threshold value interval.

Ideally, the sequence of left-right curves of the serpentine has a similar direction change in each case. However, in practice it can for example occur that a slight left curve is followed by a somewhat stronger right curve. In the case of an absolute threshold value, it can occur here that a serpentine cannot be recognized as such. This problem can be solved by means of a relative direction change threshold value interval. It is thus conceivable that a curve of a sequence of left-right curves exceeds a lower absolute direction change threshold value (and exceeds an upper absolute direction change threshold value) and thereupon a relative direction change threshold value interval can be determined for the following curves. The upper/lower relative direction change threshold value of the respective relative direction change threshold value interval can differ, for example, by ±8%, ±15%, ±20%, or ±28% from the preceding threshold value or from the upper/lower absolute direction change threshold value. It is also conceivable that a maximum range and/or a minimum value range is specified for the relative direction change threshold value interval.

A computing device according to the invention for a vehicle is configured to carry out a method according to the invention and the advantageous embodiments thereof. The computing device can be designed, for example, as an electronic control unit which comprises one or more programmable processors.

A computer-readable (storage) medium according to the invention comprises commands which, upon the execution by a computing device, prompt it to carry out a method according to the invention and the advantageous embodiments thereof.

An assistance system according to the invention for a vehicle comprises a computing device according to the invention, a computer-readable (storage) medium according to the invention, and a display device, which is configured to visualize the route section data output by the computing device. The display device can be, for example, an infotainment system, a head-up display, or the like.

A further aspect of the invention relates to a computer program, comprising commands which, upon the execution of the program by a computing device, prompt it to carry out a method according to the invention and the advantageous embodiments thereof. Furthermore, the invention relates to a vehicle comprising an assistance system according to the invention. The vehicle can be designed in particular as a passenger vehicle.

The preferred embodiments presented with respect to the method according to the invention and the advantages thereof apply accordingly to the computing device according to the invention, to the computer-readable (storage) medium according to the invention, and to the assistance system according to the invention. Furthermore, the preferred embodiments presented with respect to the method according to the invention and the advantages thereof also apply to the computer program according to the invention and to the vehicle according to the invention.

Further features of the invention result from the claims, the figures, and the description of the figures. The features and combinations of features mentioned above in the description, and the features and combinations of features mentioned below in the description of the figures and/or shown solely in the figures are usable not only in the respectively specified combination, but also in other combinations or alone, without departing from the scope of the invention.

The invention will now be explained in more detail on the basis of preferred exemplary embodiments and with reference to the appended drawings. In the figures:

### BRIEF DESCRIPTION OF THE DRAWINGS

FIG. 1 shows a schematic representation of a vehicle, comprising an assistance system for supporting a driver of the vehicle in traveling a predetermined route,

FIGS. 2a-c show schematic representations of a contracting curve, the route data, and the curvature course,

FIGS. 3a-c show schematic representations of a serpentine, an associated curvature course, and an absolute direction change course.

### DETAILED DESCRIPTION OF THE DRAWINGS

In the figures, identical or functionally-identical elements are provided with identical reference signs.

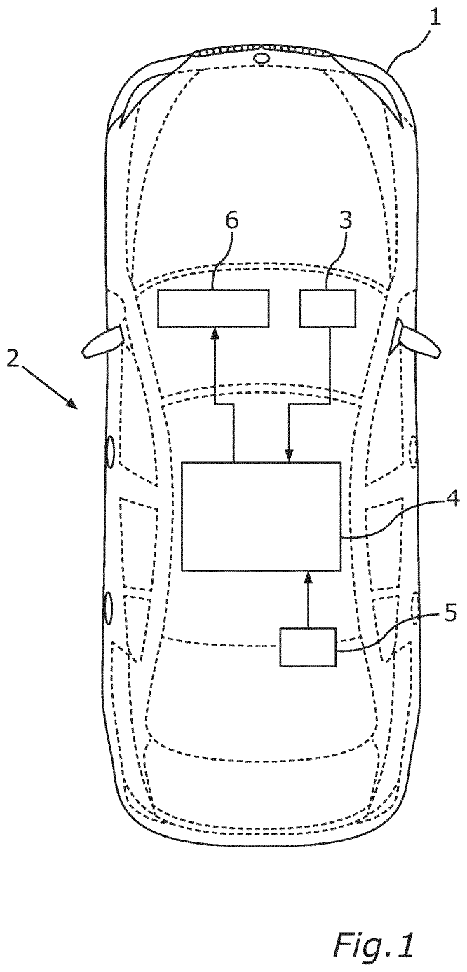

FIG. 1 shows a vehicle 1, comprising an assistance system 2 for supporting a driver of the vehicle 1 in traveling a predetermined route. Furthermore, the vehicle comprises a navigation system 3. The assistance system 2 comprises a computing device 4, a computer-readable (storage) medium 5, and a display device 6.

The computing device 4 of the assistance system 2 is configured to carry out a method for supporting a driver of the vehicle 1 in traveling a predetermined route 7 in road traffic. A corresponding computer program which comprises commands which, upon the execution of the program by a computing device 4, prompt it to carry out the corresponding method can be stored on the computer-readable (storage) medium 5.

The navigation system 3 can transmit route data to the computing device 4. A curvature course 10 can be determined by means of the route data. A first route section, which describes a section of the predetermined route 7, can be determined on the basis of the curvature course 10. Corresponding route section data, which describe the section of the predetermined route 7 by means of the first route section 11, can be output to the display device 6. The display device 6 can be, for example, a display of an infotainment system, a head-up display, or the like.

The predefined perceptibility data additionally received in the scope of the method according to the invention can be stored, for example, on the computer-readable (storage) medium 5.

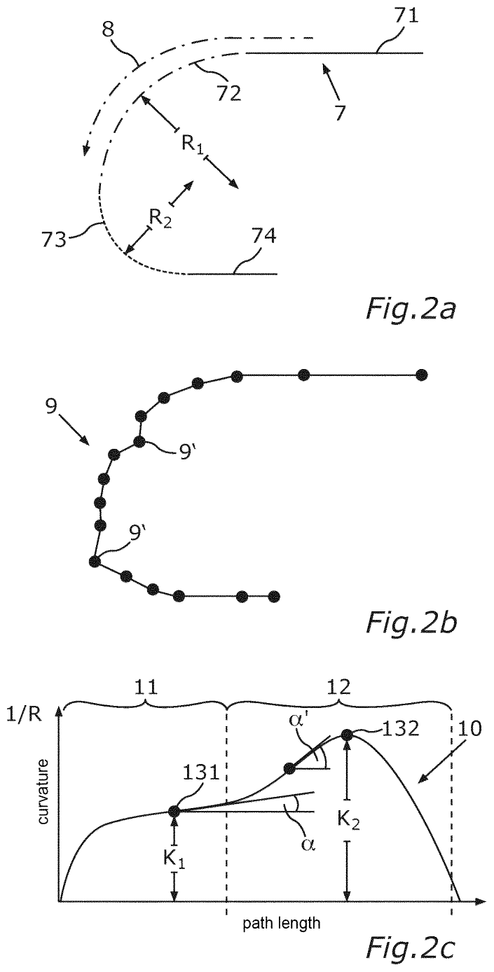

FIG. 2a shows a predetermined route 7 in stylized form, through which the vehicle 1 drives in the direction according to the arrow 8. The predetermined route 7 initially has a straight section 71. The straight section 71 is followed by a curved section 72, which has a curve radius R₁. Adjacent to the section 72, a (more strongly) curved section 73 follows, which has a curve radius R₂. Finally, a further straight section 74 follows the section 73. The combination of the curved section 72 and the (more strongly) curved section 73 can describe a contracting curve.

FIG. 2b shows, by way of example, route data in the form of individual route points 9. FIG. 2b also shows that the route points 9 can have individual outliers 9′. The exemplary route data from FIG. 2b describe the predetermined route 7 from FIG. 2a.

FIG. 2c shows the curvature course 10 determined by means of the method according to the invention corresponding to the predetermined route section 7 from FIG. 2a. Instead of only identifying a single curve, a first route section 11 and at least one further route section 12 or one second route section can be determined by means of the method according to the invention. The first route section 11 can describe the curved section 72 of the predetermined route 7. The at least one further route section 12 can describe the (more strongly) curved route section 73 of the predetermined route 7.

The curvature course 10 has the same sign in the area of the first route section 11 and in the area of the at least one further route section 12 or in the area of the second route section, wherein the same sign is represented by a curvature course 10 above the abscissa. In order to distinguish the first route section 11 from the at least one further route section 12 or from the second route section, a change of the curvature course can be taken into consideration. A saddle point 131, which is located in an area comprising the first route section 11 and the at least one further route section 12, describes a curvature K₁. In the saddle point 131, the change of the curvature course can be described by the angle a. The angle a also describes a gradient of the curvature course 10 here.

A curvature course maximum K₂ in the point 132 can describe the minimum curve radius R₂ of the predetermined route 7 shown in FIG. 2a. If the change of the curvature course, thus the angle a, falls below a curvature course change threshold value for a predetermined distance, this can describe the saddle point 131. Previous methods for route preparation and/or curve prediction often combine the curved section 72 and the (more strongly) curved route section 73 of the predetermined route 7 as a curve having a curvature K₂. By means of the method according to the invention, the first route section 11 can now be separated from the at least one further route section 12 or the second route section. The differentiation of the first route section 11 from the at least one further route section 12 or from the second route section thus enables a recognition of a contracting curve.

Furthermore, for the subdivision of the predetermined route 7 into a first route section 11 and optionally into at least one further route section 12, secondary conditions can be applied which underpin a subjective and differentiated perceptibility by the driver. This can be, for example, exceeding a threshold value for the ratio of the curvature K₁ to the curvature K₂, exceeding one or more direction change threshold values for the first route section 11 or the at least one further route section 12, and/or exceeding a threshold angle by the change in the curvature course points K₁ and K₂ (for example, in the case of the angle α′). The received route data can thus be divided into (curve) sections intuitively comprehensible for the driver.

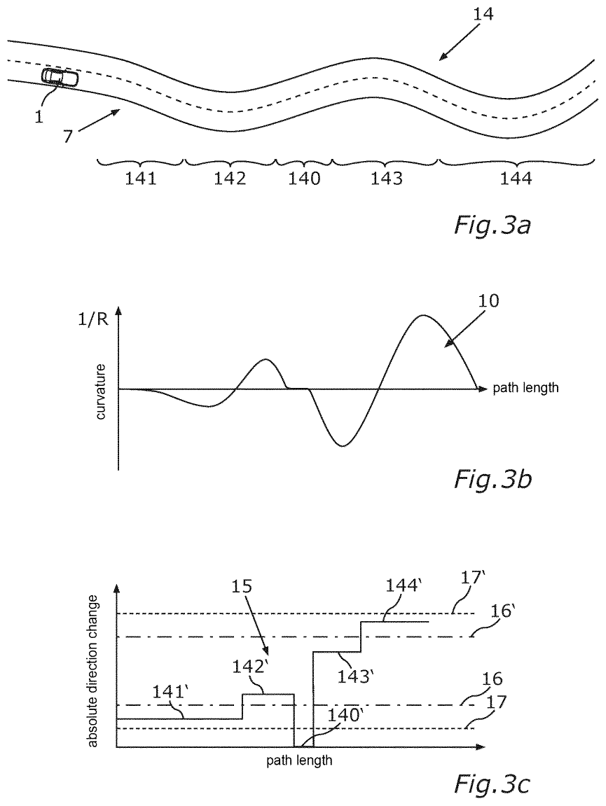

FIG. 3a shows a serpentine predetermined route 7. The vehicle 1 is located at the beginning of the serpentine 14. The serpentine 14 can be a sequence of left-right curves which only have a minor direction change in the form of an angle and as a result of which are intuitively perceived by the driver not as individual curves but rather as a contiguous route section.

In FIG. 3b—analogously to FIG. 2c—the curvature course 10 associated with the serpentine 14 from FIG. 3a is shown. The serpentine 14 is in particular characterized by a changing sign of the curvature course 10.

The absolute direction change course 15 associated with the serpentine 14 from FIG. 3a is shown in FIG. 3c. The absolute direction change course can be specified in degrees, for example. A ±90° curve can accordingly have an absolute direction change of 90°. In addition, a lower absolute threshold value 16 and an upper absolute threshold value 16′ for the direction change are shown. The absolute direction changes associated with the route sections 142 and 143 from FIG. 3a are represented in FIG. 3c by the absolute direction changes 142′ and 143′, respectively.

The absolute direction changes 142′ and 143′ are within the area delimited by the lower absolute threshold value 16 and the upper absolute threshold value 16′ and can be described in a simple manner as a serpentine 14. The first curve of the serpentine 14 can be described by the section 141. On the one hand, the radius of the curve of the section 141 is very large or the curvature of the curve of the section 141 is very small. On the other hand, the direction change 141′ of the curve of the section 141 is also so small that the lower absolute threshold value 16 is not exceeded and the section therefore cannot be assigned a priori to the serpentine 14, although the driver would intuitively expect this.

A relative direction change threshold value or a direction change threshold value interval having a lower relative direction change threshold value 17 and an upper relative direction change threshold value 17′ can solve this problem. A lower relative direction change threshold value 17 is shown in FIG. 3c. The lower relative direction change threshold value 17 can deviate, for example, by 15% from the lower absolute threshold value 16. However, it is also conceivable that the lower relative direction change threshold value 17 deviates by, for example, 20% from the absolute direction change 142′ of the following section 142 or the following curve.

This applies analogously to the section 144 and the associated absolute direction change 144′. For example, the upper relative direction change threshold value 17′ can deviate by 20% from the absolute direction change 143′ or the preceding curve or by, for example, 15% from the upper absolute threshold value 16′. The respective curves of the route sections 141, 142, 143, and 144 can either be directly neighboring (thus adjacent to one another) or separated by a (short) straight part, represented by the route section 140. In other words, it is thus also conceivable that the serpentine 14 comprises a (short) straight part, which does not exceed, for example, a predetermined length and/or duration during the drive through, in order thus to take into consideration the subjective perceptibility by the driver. The method according to the invention for determining a serpentine 14 by means of relative direction change threshold value intervals therefore defines a hysteresis.

1-12. (canceled)

13. A method for supporting a driver of a vehicle in traveling a predetermined route in road traffic, the method comprising:
receiving route data which describe the predetermined route;
determining a curvature course that describes a curvature of the predetermined route;
determining a first route section based on the curvature course, wherein the first route section describes a section of the predetermined route; and
outputting route section data, which describe the section of the predetermined route based on the first route section;
wherein predefined perceptibility data are additionally received, which describe a driving-dynamics feeling of the driver in traveling the section of the predetermined route; and
wherein the determination of the first route section is carried out based on the perceptibility data and additionally in consideration of a change of the curvature course.

14. The method according to claim 13, wherein the predefined perceptibility data comprise a relative value and/or a road category, wherein the relative value describes the driving-dynamics feeling relative to an adjacent section of the predetermined route and the road category characterizes a roadway.

15. The method according to claim 13, wherein the route section data comprise at least one first route section point and one second route section point.

16. The method according to claim 14, wherein the route section data comprise at least one first route section point and one second route section point.

17. The method according to claim 13, wherein the section of the predetermined route described by the first route section represents a curve.

18. The method according to claim 14, wherein the section of the predetermined route described by the first route section represents a curve.

19. The method according to claim 15, wherein the section of the predetermined route described by the first route section represents a curve.

20. The method according to claim 13, wherein
in the determination of the first route section, a direction change of the section of the predetermined route described by the first route section is additionally determined, and
the first route section is characterized as a curve if the direction change exceeds a predetermined direction change threshold value.

21. The method according to claim 14, wherein
in the determination of the first route section, a direction change of the section of the predetermined route described by the first route section is additionally determined, and
the first route section is characterized as a curve if the direction change exceeds a predetermined direction change threshold value.

22. The method according to claim 15, wherein
in the determination of the first route section, a direction change of the section of the predetermined route described by the first route section is additionally determined, and
the first route section is characterized as a curve if the direction change exceeds a predetermined direction change threshold value.

23. The method according to claim 13, wherein
in addition to the determination of the first route section, at least one further route section is determined based on the curvature course,
the at least one further route section is adjacent to the first route section and a sign of the curvature course of the first route section is identical to a sign of the curvature course of the at least one further route section, and
the route section data describe the section of the predetermined route based on the first route section and the at least one further route section.

24. The method according to claim 14, wherein
in addition to the determination of the first route section, at least one further route section is determined based on the curvature course,
the at least one further route section is adjacent to the first route section and a sign of the curvature course of the first route section is identical to a sign of the curvature course of the at least one further route section, and
the route section data describe the section of the predetermined route based on the first route section and the at least one further route section.

25. The method according to claim 15, wherein
in addition to the determination of the first route section, at least one further route section is determined based on the curvature course,
the at least one further route section is adjacent to the first route section and a sign of the curvature course of the first route section is identical to a sign of the curvature course of the at least one further route section, and
the route section data describe the section of the predetermined route based on the first route section and the at least one further route section.

26. The method according to claim 23, wherein the curvature course in an area which comprises the first route section and the at least one further route section has a saddle point, wherein the saddle point is characterized by the change of the curvature course which falls below a curvature course change threshold value for a predetermined distance.

27. The method according to claim 24, wherein the curvature course in an area which comprises the first route section and the at least one further route section has a saddle point, wherein the saddle point is characterized by the change of the curvature course which falls below a curvature course change threshold value for a predetermined distance.

28. The method according to claim 13, wherein
in addition to the determination of the first route section, at least one further route section is determined based on the curvature course,
the at least one further route section is adjacent to the first route section and a sign of the curvature course of the first route section is different from a sign of the curvature course of the at least one further route section, and
the route section data describe the section of the predetermined route based on the first route section and the at least one further route section as a serpentine.

29. The method according to claim 28, wherein
in the determination of the first route section and the at least one further route section, in addition a direction change of the section of the predetermined route described by the respective route section is determined, and
the route section data describe the section of the predetermined route as a serpentine if the respective direction change is located within a respective relative direction change threshold value interval.

30. A computing device for a vehicle, which is configured to carry out a method according to claim 13.

31. A non-transitory computer-readable medium storing commands which, upon execution by a computing device, prompt the computing device to carry out a method according to claim 13.

32. An assistance system for a vehicle, comprising:
a computing device configured to carry out a method according to claim 13;
a non-transitory computer-readable medium storing commands which are executed by the computing device; and
a display device configured to display the route section data that is output by the computing device.
